(19) United States
(12) Patent Application Publication
(10) Pub. No.: US 2008/0301699 A1
(43) Pub. Date: Dec. 4, 2008

(54) Apparatus and methods for workflow management and workflow visibility

(76) Inventor: Darren B. Macer, Seattle, WA (US)

Correspondence Address: HARNESS DICKEY & PIERCE, PLC, P.O. BOX 828, BLOOMFIELD HILLS, MI, 48303, US

(21) Appl. No.: 11/809,492

(22) Filed: Jun. 1, 2007

(51) Int. Cl. G06F 9/46

(52) U.S. Cl. 718/107

(57) ABSTRACT

A system for viewing and managing work flow. The system includes at least one processor and memory configured to track time requirements for each of a plurality of jobs, compile and display the time requirements relative to current time in a plurality of managerial-level views, and in each view, indicate status of the jobs relative to the time requirements.

### FIELD

The present disclosure relates generally to workflow management and more particularly to a visibility and workflow management tool that uses current and historical data to predict work.

### BACKGROUND

The statements in this section merely provide background information related to the present disclosure and may not constitute prior art. In a large enterprise, it can be difficult to comprehend and manage in a timely manner the volume of work and different types of jobs that may be requested of large numbers of people and various work groups.

### SUMMARY

The present disclosure, in one implementation, is directed to a system for viewing and managing work flow. The system includes at least one processor and memory configured to track time requirements for each of a plurality of jobs, compile and display the time requirements relative to current time in a plurality of managerial-level views, and in each view, indicate status of the jobs relative to the time requirements.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic view of enterprise operations using a visibility tool in accordance with one implementation of the disclosure;

FIG. 2 is a view of a record including data descriptive of a job request and job resolution in accordance with one implementation of the disclosure;

FIG. 3 is a view of a record including data descriptive of employee shift data in accordance with one implementation of the disclosure;

FIG. 4 is a view of a record including data descriptive of employee staffing in accordance with one implementation of the disclosure;

FIGS. 5-8 are views of hourly job data in accordance with one implementation of the disclosure;

FIG. 9 is a director-level view of data in accordance with one implementation of the disclosure;

FIG. 10 is a second-level manager view of data in accordance with one implementation of the disclosure;

FIG. 11 is a first-level manager view of data in accordance with one implementation of the disclosure;

FIG. 12 is a group-leader view of data in accordance with one implementation of the disclosure;

FIG. 13 is a multi-group view in accordance with one implementation of the disclosure;

FIGS. 14 and 15 are customer job status views in accordance with one implementation of the disclosure; and

FIGS. 16-18 are seating chart views in accordance with one implementation of the disclosure.

### DETAILED DESCRIPTION

The following description is merely exemplary in nature and is not intended to limit the present disclosure, application, or uses. In a large enterprise, when customers request work to be performed, it is highly desirable to know whom to best assign the work to, both individually and by group, and to be able to respond accurately to customers' inquiries, e.g., by providing an overall status of workload and due time. Various implementations of the present disclosure provide management personnel with a tool that enables them to quickly and accurately respond to the numerous inquiries typically made by customers of a large enterprise. Staff and management can understand how work is being allocated and/or completed in real time. Various implementations of the present disclosure make it possible for staff and management to know, e.g., which individuals or groups are busy and which are idle and can take on more workload.

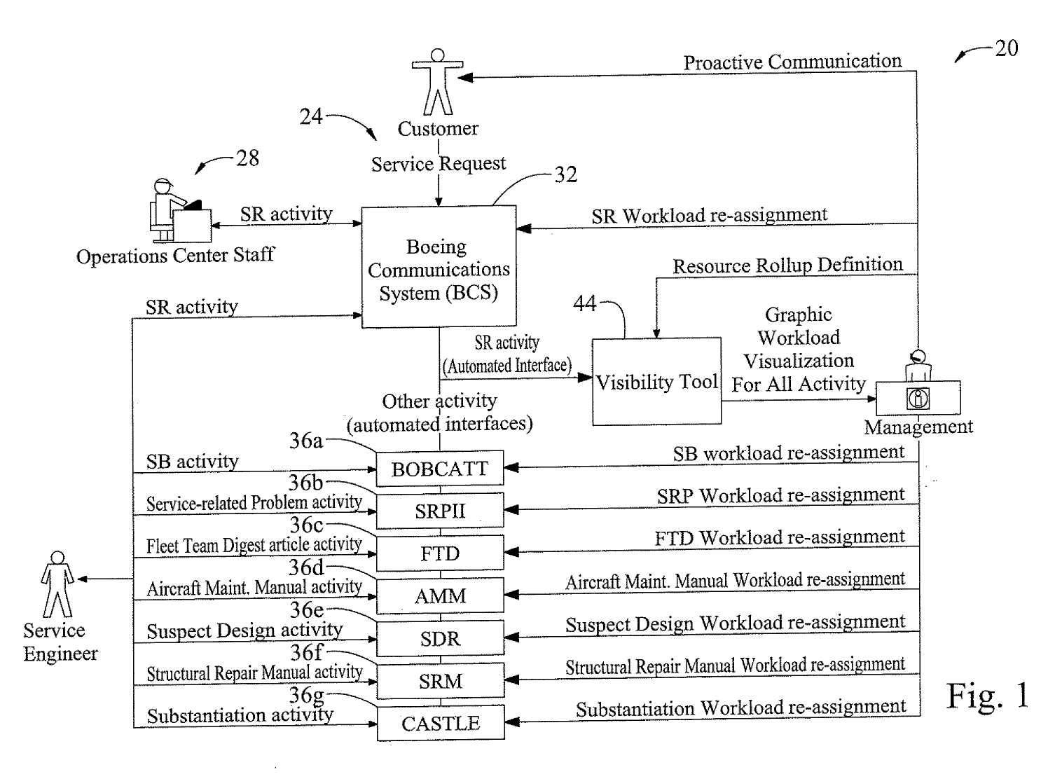

A view of enterprise operations in which a visibility tool is used in accordance with one implementation of the disclosure is indicated generally in FIG. 1 by reference number 20. In the present example, the enterprise manufactures and services aircraft for a plurality of airlines and other customers. It should be noted, however, that the disclosure is not so limited. The disclosure may be implemented in relation to many different types of businesses and in relation to many different arrangements of employees and work assignments.

In enterprise operations 20, a service engineer can have responsibility for a plurality of job assignments. A work assignment typically comes from one of two sources. A job may be assigned reactive to a customer service request, or assigned pro-actively by in-house management. A customer service request 24 typically is made by a customer, and/or by staff of an operations center 28, through a communications system 32. In performing a job of a particular type, a service engineer may communicate with and/or be subject to constraints through one of a plurality of activity interface or systems 36A-36g. For example, service bulletins may be logged in the system 36a, and structural repair manual activity may be performed with reference to a structural repair manual interface 36f. In such an enterprise, assignment of work and oversight of work assignments can be complex.

In one configuration, a visibility and workflow management tool 44 uses historical data to predict work based, e.g., on time of day, day of week, and/or week of year. Such information may be used to determine the workflow status for individual groups, based on current and projected manpower. The tool 44 provides a graphic means of showing which groups need help, which are available to help and where work and manpower need to be directed. The tool 44 can be used to allow an organization with remote groups to see and assign a work project fluidly to a person, or group, who is available to work on the project without significantly impacting group performance as a whole. The tool 44 can determine how complete each of a plurality of jobs is, the complexity of each job, and remaining time available for completing the job. It can be determined, for example, whether a job is at risk or on track or if a person is able to take on more work.

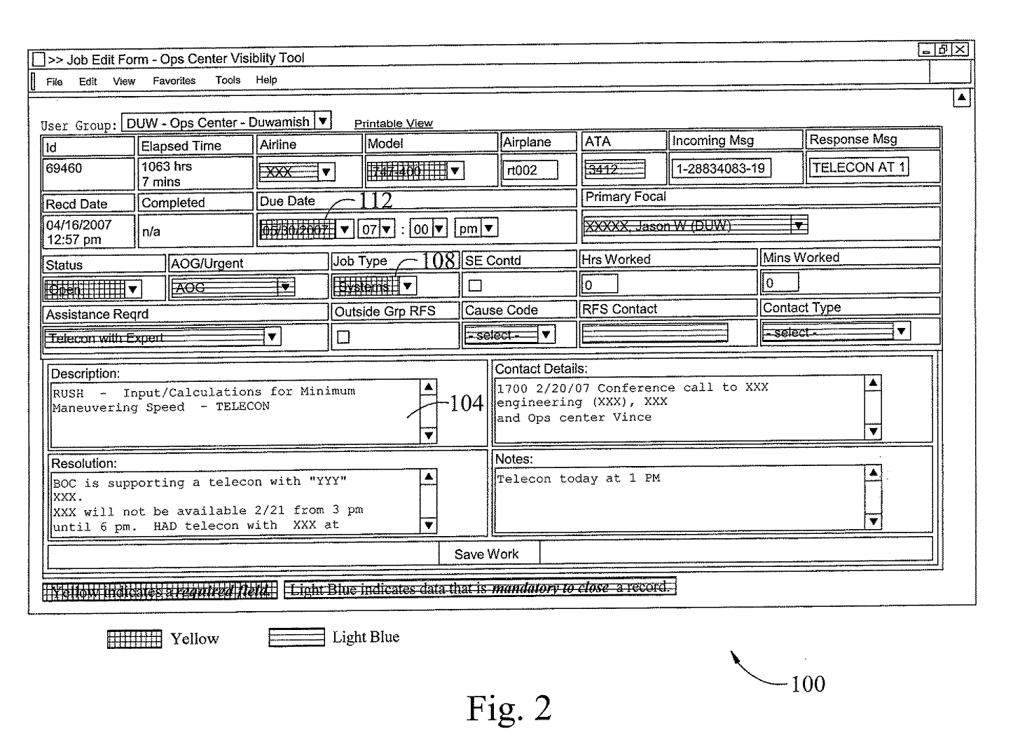

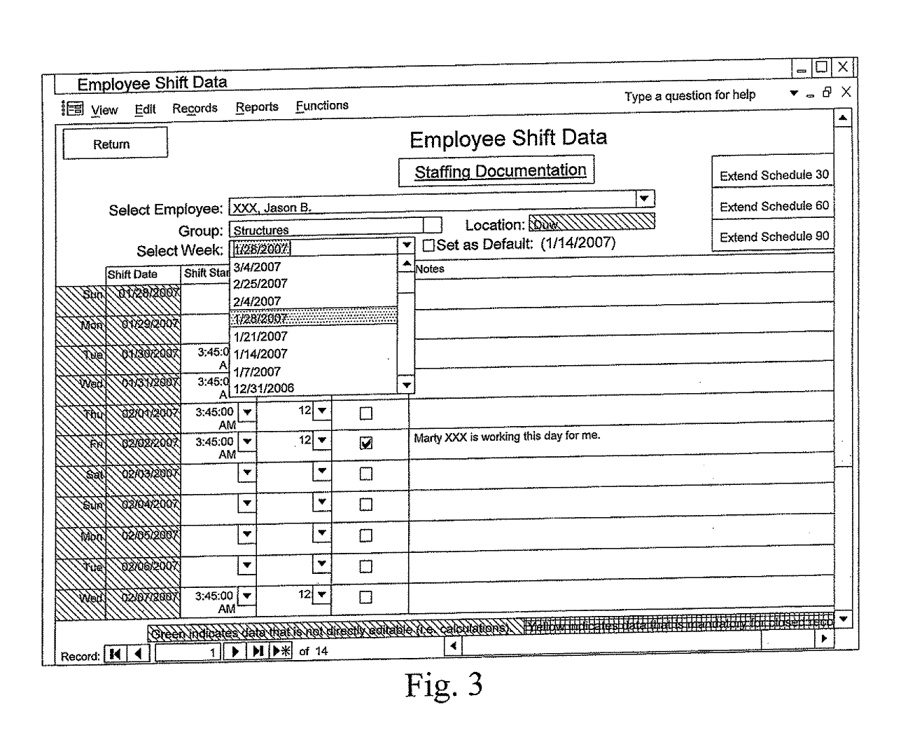

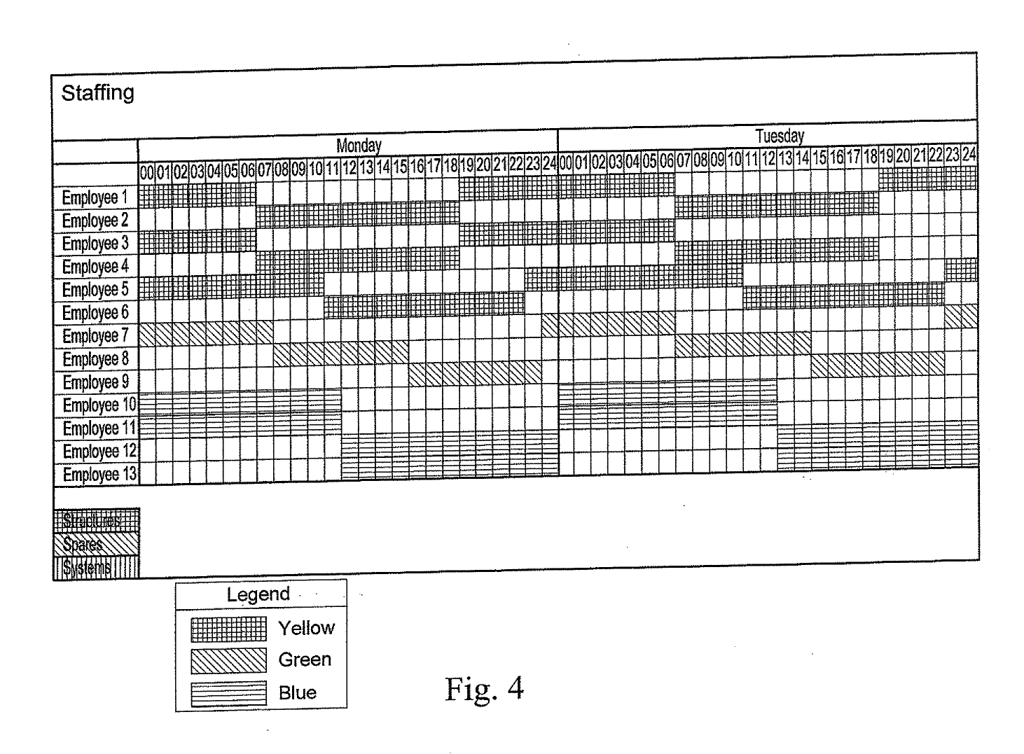

A job may be requested and tracked, e.g., using a record indicated generally by reference number 100 in FIG. 2. Information from the record 100, including a job description 104, job type 108, and due date 112, is input to the visibility tool 44. The record 100 may be updated as the job progresses. Employee shift data, as shown in FIG. 3, and staffing data, as shown in FIG. 4, also are input to the visibility tool 44.

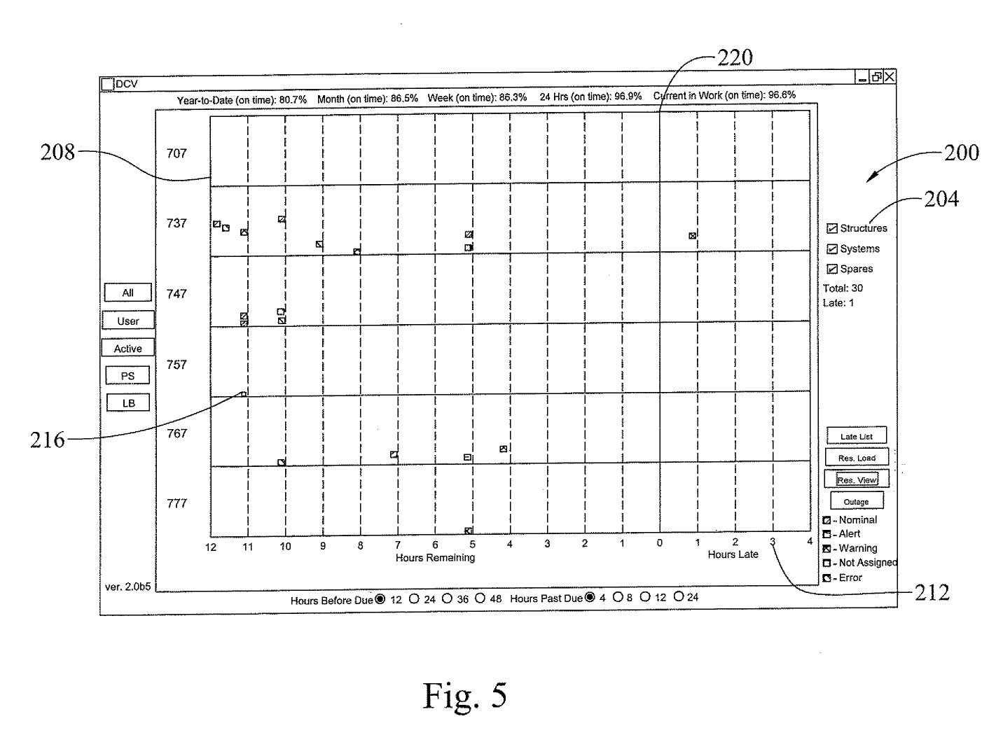

For work requests for which a response time is defined to the hour, jobs may be displayed in a viewer window indicated generally in FIG. 5 by reference number 200. The window 200 can be used to provide a graphical representation of current jobs for one or more specified job types 204, when the jobs are due, what aircraft type(s) they are for, and whether a job has been assigned to anyone for work. The window 200 allows a person assigning work to assess which jobs should obtain a high priority and to forecast short term staffing requirements.

Aircraft model types are displayed along a vertical axis 208 and hours remaining are displayed along a horizontal axis 212. Jobs are located on the screen 200 depending on the associated model type, time due and job status. Such information is provided real time, i.e., markers 216 indicating jobs are moved in real time toward (and perhaps past) a vertical “now line” 220. Jobs are coded by color, e.g., a green marker 216 indicates a job that is assigned, is being worked on, and has more than 30 minutes until its due time. Any of the markers 216 can be selected by a user to display a window that provides pertinent information for the job.

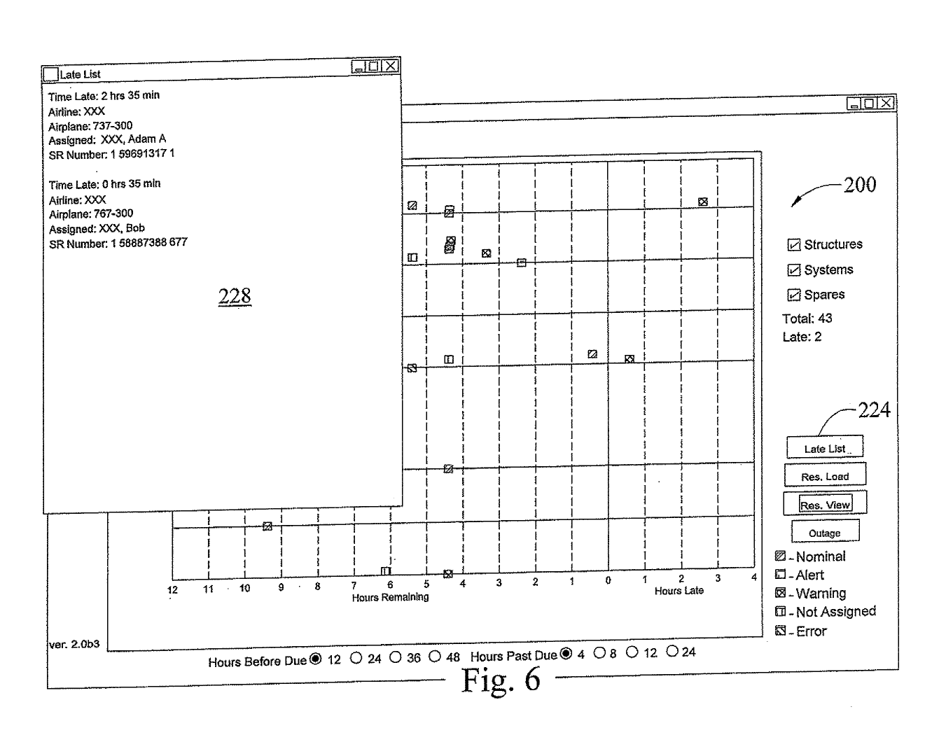

Referring to FIG. 6, when a job has less than 30 minutes remaining until its due time, its marker color changes to yellow. When a job is out of time or late, its marker color is red. When a new job appears that is not assigned to anyone, its marker color is white. Of course, colors referred to in the disclosure are only exemplary, and other colors and/or marker types could be used. Additionally, it should be understood that different numbers and kinds of job types, and/or different time parameters, could be provided for in other implementations. As shown in FIG. 6, when a “Late List button” 224 is selected, a list 228 of all currently late jobs is displayed.

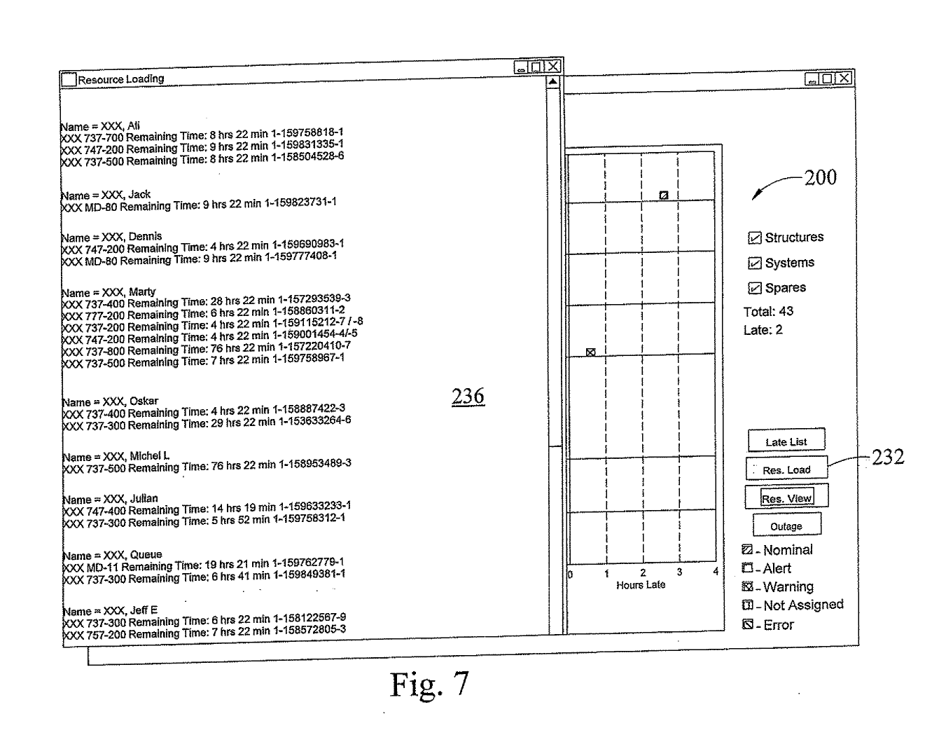

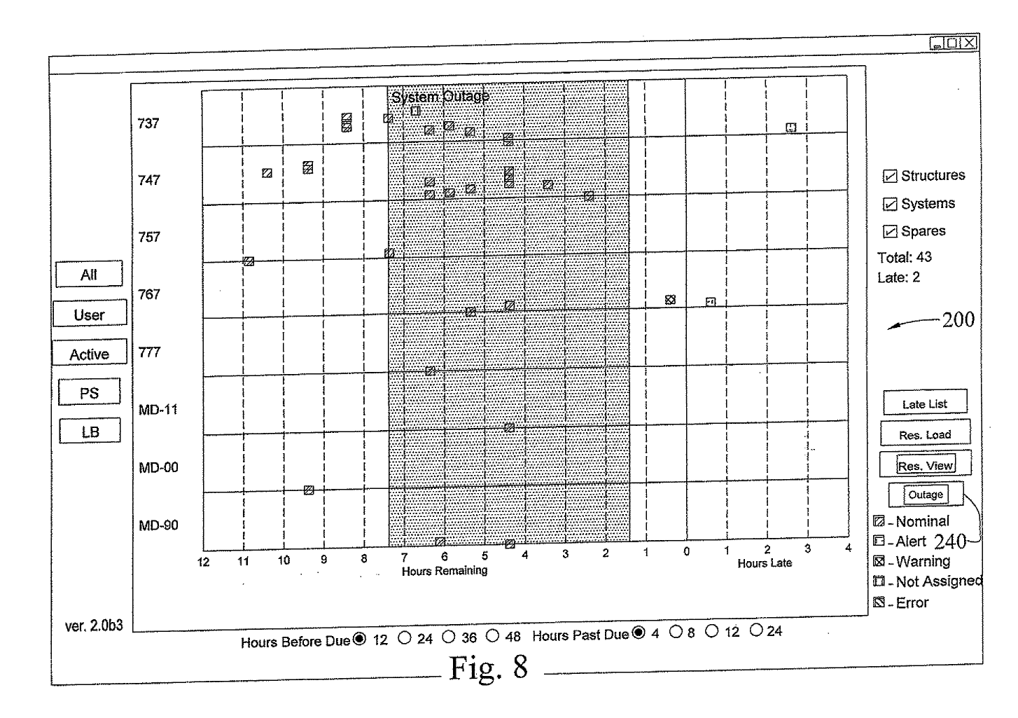

Referring to FIG. 7, when a “Res. Load” button 232 is selected, a list 236 of all assigned jobs is shown, e.g., with details such as employee name and service request number for each job. Referring to FIG. 8, when an “Outage” button 240 is selected, system outages are displayed, thereby allowing a user to show how current due times may relate to an outage of a given system. A user may then reschedule work to account for the system outage.

Various levels of viewing workflow and workflow-related information may be provided based, e.g., on a viewer's management level. For example, dependent on an employee's position, the employee may use the tool 44 to view an amount of work assigned to himself or herself, to a lead group, to a first-level manager group, to a second-level manager group, and/or to a director level. Status of a job may be shown, e.g., based on a current amount of work to be completed, number of available people, due time of the job, complexity of the job, and amount of time an individual has remaining on shift.

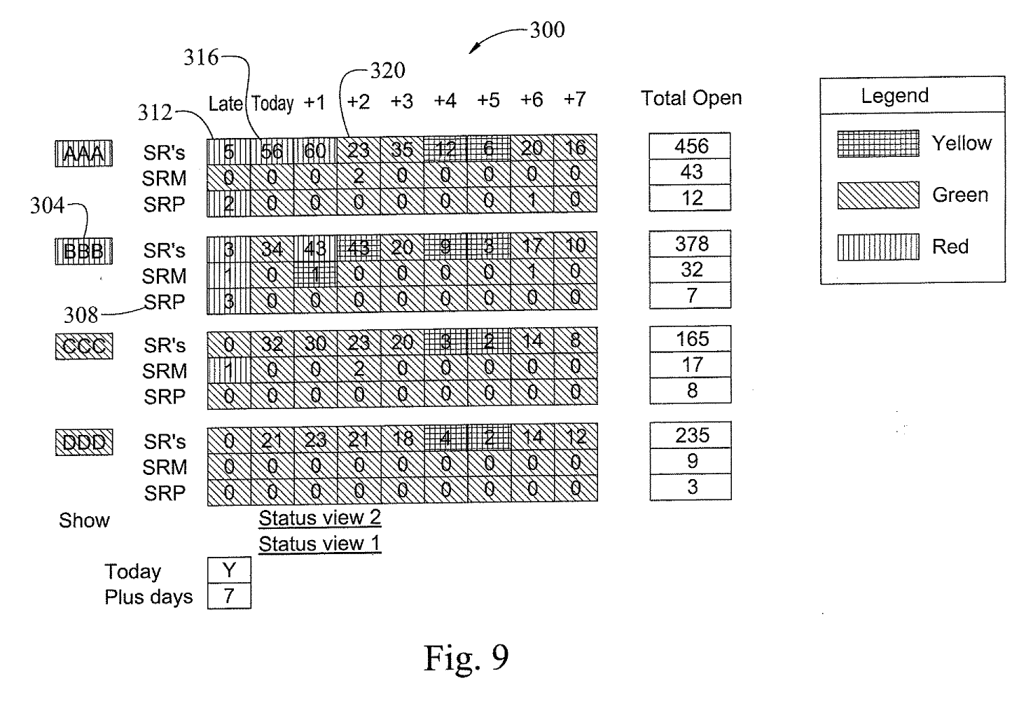

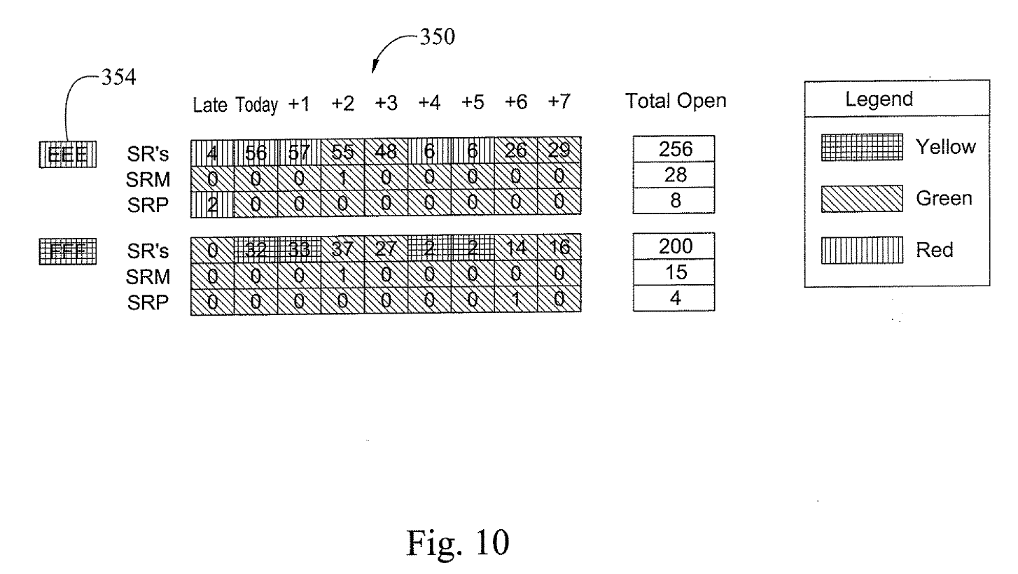

A director-level view is indicated generally in FIG. 9 by reference number 300. The view 300 displays job status for each of four second-level managers 304 who report to the director for whom the view 300 is configured. Jobs are indicated by job type 308 and also as to whether they are late 312, due the current day 316, and whether they are due for each of the next seven days 320. By selecting a second-level manager 304 in the view 300, a director may cause a view to be displayed as shown in FIG. 10. A second-level manager view is indicated generally in FIG. 10 by reference number 350. The view 350 displays job status for each of two first-level managers 354 who report to the second-level manager for whom the view 350 is configured.

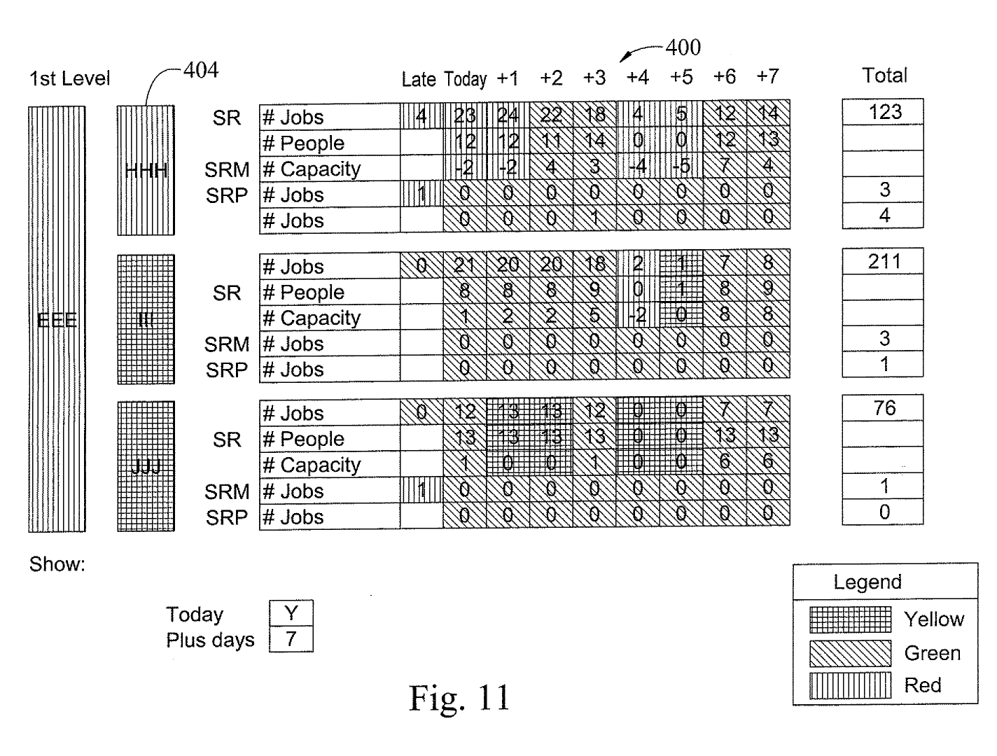

By selecting a first-level manager 354 in the view 350, a director (or second-level manager viewing the view 350) may cause a view to be displayed as shown in FIG. 11. A first-level manager view is indicated generally in FIG. 11 by reference number 400. The view 400 displays job status for each of three group leaders 404 who report to the first-level manager for whom the view 400 is configured.

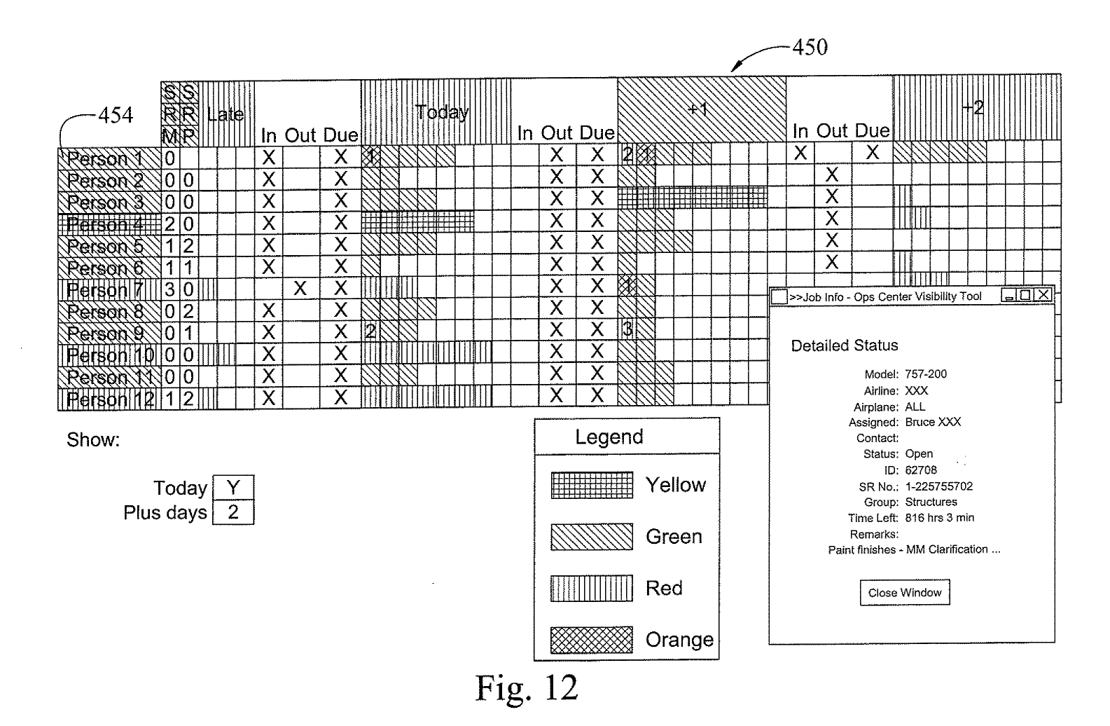

By selecting a group leader 404 in the view 400, a director (or second- or first-level manager viewing the view 400) may cause a view to be displayed as shown in FIG. 12. A lead view is indicated generally in FIG. 12 by reference number 450. The view 450 displays job status for each of twelve persons 454 in a group who report to the group leader for whom the view 450 is configured. A job may be assigned a severity level based on predefined criteria to determine a projected elapsed time for that job. Severity levels may change automatically based on actual values of completed jobs. Based on an amount of work that is due for a given group, considered together with a number of people available and remaining time, a “defense readiness condition”-type indication may be displayed, e.g., using red, yellow and green to indicate status, when individuals, lead groups, first-level managers and/or second-level manager are in need of help, or if they are able to provide help to other groups. Thus, for example, as shown in the lead view 450, the status of a lead group is indicated by displaying, by individual, all jobs that are assigned to the group.

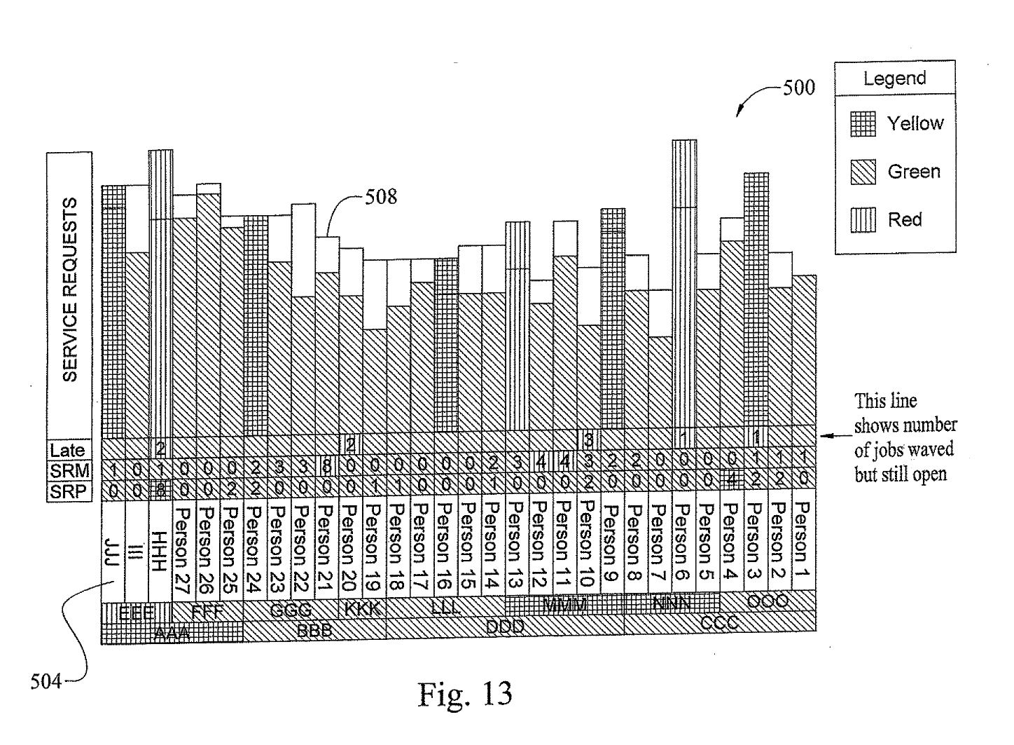

A multi-group view is indicated generally in FIG. 13 by reference number 500. The view 500 shows work assigned to each group 504. Currently existing capacity for work by a group is indicated by a line 508 for each group. Information in the view 500 thus may be used manually and/or automatically to reallocate work among groups to even out work assignments.

In some implementations and as shown in the Figures, color may be used to indicate status in the following manner. Status of an upper managerial level is based on a combination of lower-level management status for each day. Manager level colors for each day are determined by the sum of messages on individual days at the group leader level. Any day with late jobs is shown as red. If a manager has more than one red day, the color is red. If a manager has one red day, but demand does not exceed capacity by more than 20% overall, status is yellow. If a manager has more than one yellow day, the color is yellow. If a manager has one yellow day, but demand does not exceed capacity by more than 20%, overall status is green. Lead level colors for each day are determined by the individual days on the lead level chart. Any late jobs are shown as red. If a lead has more than one red day, the color is red. If a lead has one red day, but demand does not exceed capacity by more than 20%, overall status is yellow. If a lead has more than one yellow day, the color is yellow. If a lead has one yellow day, but demand does not exceed capacity by more than 20%, overall status is green. The color level of the first-level manager is determined by the color of the leads.

Jobs that are late are automatically red. Jobs that have more than one due date change are automatically red. Jobs that have one due date change are automatically yellow. If someone is not set to “in” and has jobs due that day, they are automatically red. If someone is not “due” on a certain day and jobs are due that day, they are automatically red. If a person's work load for one day exceeds the average by 10%, they are yellow. If a person's work load for one day exceeds the average by 20%, they are red. If a day has more than two yellow people, the group is yellow. If a day has more than two red people, the group is red. It should be noted generally that the foregoing status indications are exemplary, and that other or additional ways of indicating jobs and timing could be used.

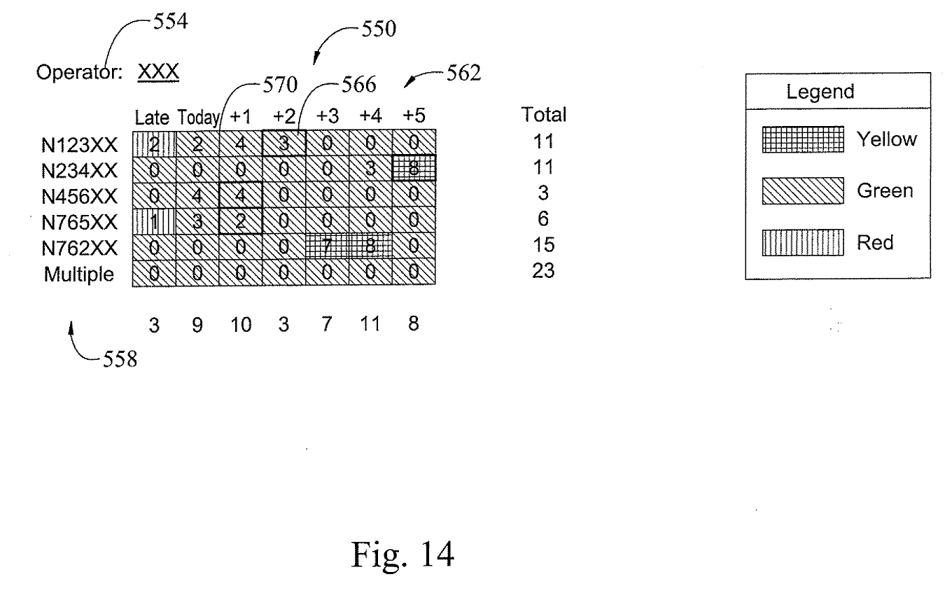

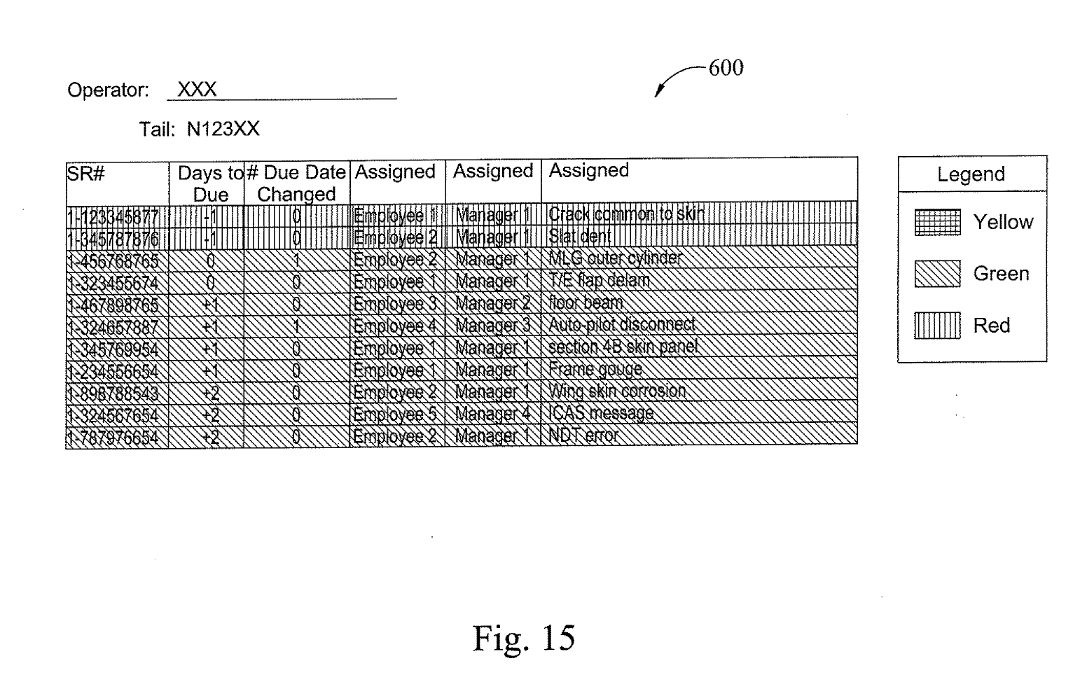

A view displaying job status for a customer is indicated generally in FIG. 14 by reference number 550. The view 550 displays the status of jobs for a customer 554, by tail number along a vertical axis 558 and time along a horizontal axis 562. An outlined block 566 indicates an asset need date. Typically and as in the foregoing views, selection of a displayed element causes information underlying the data shown in the selected element to be displayed, e.g., as shown in FIG. 15. A view of information pertaining to one of the tail numbers is indicated generally in FIG. 15 by reference number 600.

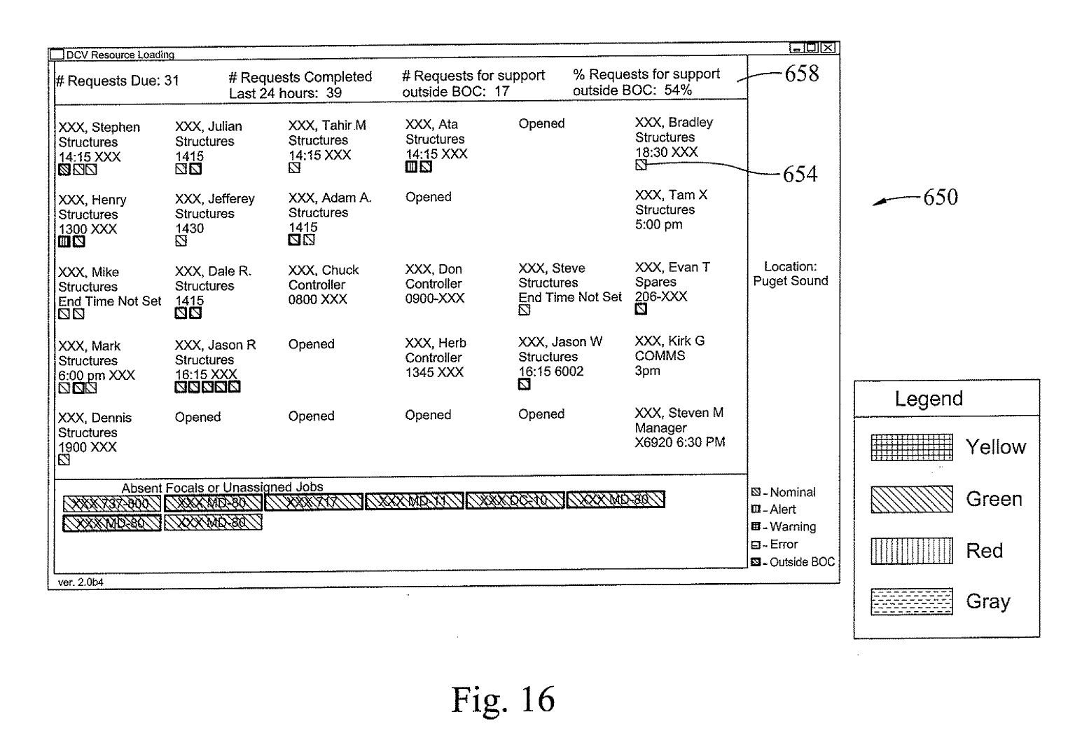

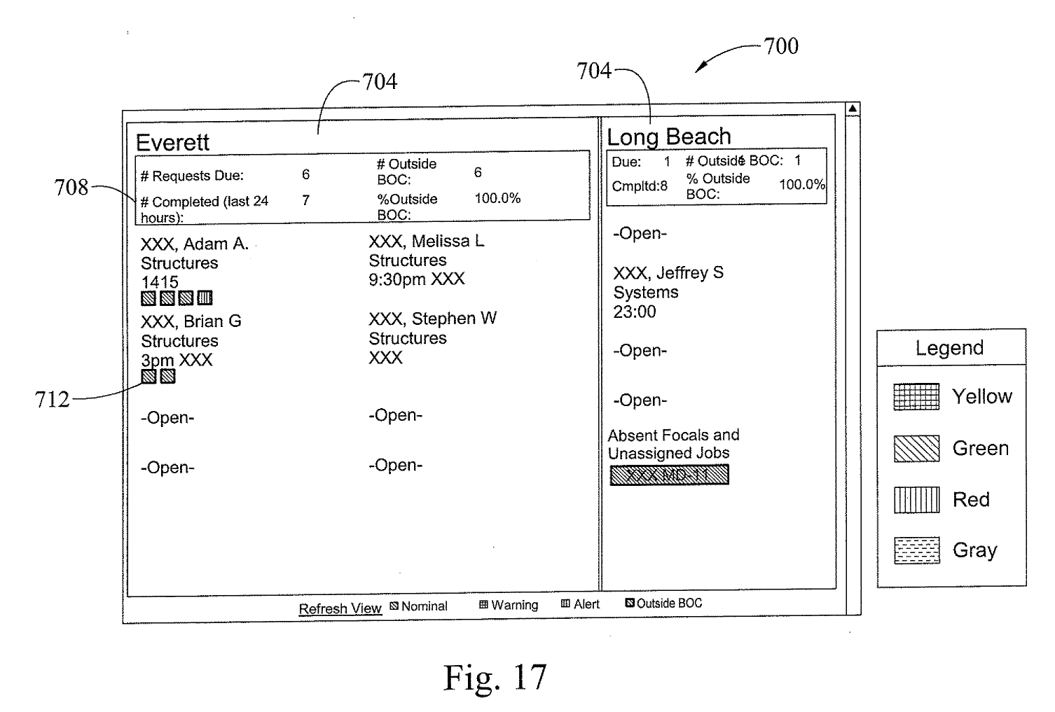

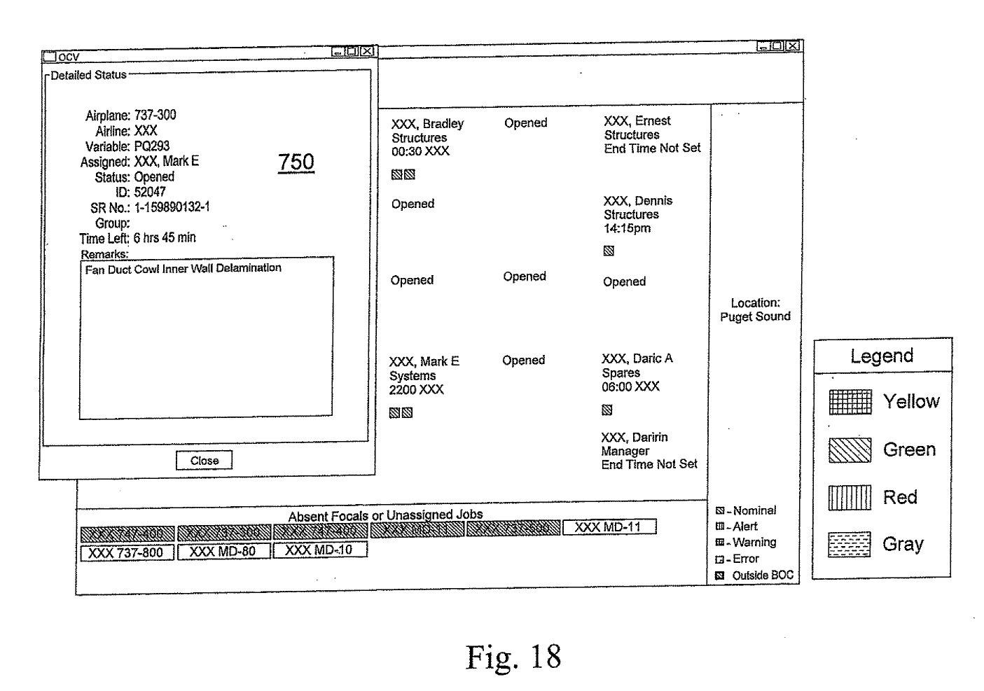

Referring to FIG. 1, in the present exemplary implementation, the operations center 28 is staffed 24 hours per day with multiple shifts and different people sharing different desks at various times. Thus the desk location of a particular staff person at a particular time is generally unpredictable. Accordingly, a seating chart view is provided as indicated generally in FIG. 16 by reference number 650. The seating chart 650 provides a graphical representation of the seating positions of individuals and shows how much work is assigned to each individual. The view 650 shows whether a particular job is being completed inside the local area, or whether it has been sourced out. Each job may be indicated as previously described, i.e., by red, yellow, green and white markers 654. The view 650 shows the seating for a main center 28 and the metrics along the view top 658 are for the main center 28. A view indicated generally in FIG. 17 by reference number 700 shows seating and job allocation at two separate satellite locations 704. Each group can see the work allocation of other centers. Each location has its own metrics along the top 708 of the screen. As shown in FIG. 18, each of the job markers on the seating charts 150 and 700 can be selected to bring up a window 750 that provides pertinent information for the selected job.

The foregoing system allows an enterprise to manage work and employees, to ensure that optimal workloads are directed to work locations that can produce the work when needed. Customers can benefit when they receive responses to their requests in a timely manner.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

1. A system for viewing and managing work flow in an enterprise in which a plurality of persons may be assigned jobs, the system comprising at least one processor and memory configured to:
receive a plurality of requests for performance of jobs;
associate each of the jobs with a projected time by which the job is to be completed and with a person assigned to complete the job;
associate each of the plurality of persons with one of a plurality of groups, each group subject to a plurality of levels of oversight;
use the projected times to determine a current work load of each person and a current work load of each group; and
use the projected times and current work loads to provide a plurality of views, each view providing at an oversight level associated with the view, current status information as to capacity for additional work.

2. The system of claim 1, wherein the at least one processor and memory are further configured to:
use the projected times to assign job status indicators to the jobs at a given one of the oversight levels; and
use the assigned job status indicators and current work loads to assign oversight status indicators to provide a view at an oversight level that includes oversight of the given oversight level.

3. The system of claim 2, wherein the at least one processor and memory are further configured to display the status indicators relative to a plurality of due dates.

4. The system of claim 1, wherein the at least one processor and memory are further configured to use information provided in a plurality of views for a first oversight level to provide information in a view for a second oversight level that includes oversight of the first oversight level.

5. The system of claim 1, wherein the at least one processor and memory are further configured to assign a status indicator to a group based on the current status information as to capacity for additional work.

6. The system of claim 5, wherein the at least one processor and memory are further configured to change the assigned status indicator based on completion of one or more of the jobs.

7. The system of claim 1, wherein the at least one processor and memory are further configured to assign a status indicator to a group based on one or more due times of one or more of the jobs.

8. A system for viewing and managing work flow in an enterprise in which a plurality of persons may be assigned jobs, the system comprising at least one processor and memory configured to:
receive a plurality of requests for performance of jobs;
associate each of the jobs with a projected time by which the job is to be completed and with a person assigned to complete the job;
associate each of the plurality of persons with one of a plurality of groups, each group subject to one or more levels of oversight;
use the projected times to determine a current work load of each person and a current work load of each group; and
use the projected times and current work loads to provide a plurality of views, each view providing current status information as to at least one of the jobs at an oversight level associated with the view.

9. The system of claim 8, wherein the at least one processor and memory are configured to:
use the projected times to assign job status indicators to the jobs at a given one of the oversight levels; and
use the assigned status indicators and current work loads to assign oversight status indicators for an oversight level that includes oversight of the given oversight level.

10. The system of claim 9, wherein the at least one processor and memory are configured to display the status indicators for each of a plurality of due dates.

11. The system of claim 8, wherein the at least one processor and memory are configured to display a plurality of status indicators for each of a plurality of due dates.

12. The system of claim 8, wherein the at least one processor and memory are further configured to assign a status indicator to a group based on current status information as to capacity for additional work.

13. The system of claim 8, wherein a group is associated with a work location of the enterprise, and a view provides a seating location of each person of the group.

14. The system of claim 13, wherein the view provides seating locations for a plurality of enterprise work locations.

15. A method of viewing and managing work flow in an enterprise in which a plurality of persons may be assigned jobs, the method comprising:
receiving a plurality of requests for performance of jobs;
associating each of the jobs with a projected time for job completion and with a person assigned to complete the job;
identifying one or more of the assigned persons as being present at a work location of the enterprise;
using one or more of the projected times to determine a current work status for each identified person and a current work status for the work location; and
providing a view representing the one or more identified persons relative to the work location, the view further representing the current work statuses.

16. The method of claim 15, further identifying in the view a job request unassigned to a person.

17. The method of claim 15, wherein the current work status includes a projected time remaining for completing one of the jobs.

18. The method of claim 15, wherein the work location includes a satellite location of the enterprise.

19. The method of claim 18, wherein representing the one or more identified persons relative to the work location comprises representing one or more desk locations.

20. The method of claim 15, further comprising:
identifying a plurality of the assigned persons as being present at a plurality of work locations of the enterprise;
using a plurality of the projected times to determine a current work status for each identified person and a current work status for each work location; and
providing a view representing the identified persons relative to the work locations, the view further representing the current work statuses.
